(19) United States
(12) Patent Application Publication
(10) Pub. No.: US 2017/0157626 A1
(43) Pub. Date: Jun. 8, 2017

(54) Anti-drip showerhead

(71) Applicant: Sze Man Daphne CHAN, Kowloon (HK)

(72) Inventor: Sze Man Daphne CHAN, Kowloon (HK)

(21) Appl. No.: 14/958,866

(22) Filed: Dec. 3, 2015

(51) Int. Cl. B05B 1/18; B05B 1/30; B05B 15/06; B05B 15/04

(52) U.S. Cl. CPC B05B 1/185; B05B 15/0406; B05B 1/3006; B05B 15/066

(57) ABSTRACT

The present invention is an anti-drip showerhead which includes a body, a cover plate and a plurality of spray outlets opened on the cover plate. Each of the spray outlets comprises an anti-drip means chamber at a first end and at least one spray outlet opening at a second end opposite the first end; the anti-drip means chamber and the spray outlet opening are in water communication with each other; each of the anti-drip means chambers is disposed with a water pressure actuated anti-drip means which is operable between an open position where water from the body is allowed to pass through the anti-drip means and exits through the spray outlet opening and a close position where water from the body is blocked by the anti-drip means and thus could not exit through the spray outlet opening.

### BACKGROUND OF THE INVENTION

The present invention relates to a showerhead and more particularly pertains to an anti-drip showerhead.

A traditional showerhead generally comprises a body and a cover plate. Water from a water supply enters the body via a water inlet and exits the body via spray outlet openings on the cover plate. After a user turns off a faucet which stops water from the water supply from entering the body, there is still a significant amount of water remained in the body, and thus the water remained in the body continues to drip out from the spray outlet openings on the cover plate until there is no water remaining in the body. Such water dripping creates inconvenience and nuisance for the user.

### BRIEF SUMMARY OF THE INVENTION

In view of the aforesaid disadvantages now present in the prior art, the present invention provides an anti-drip showerhead which is simple in structure and minimizes water dripping from spray outlet openings on the cover plate of the showerhead after the water supply is switched off.

To attain this, the present invention generally comprises:

a body;

a cover plate attached to one end of the body in a water-sealed manner;

a plurality of spray outlets opened on the cover plate;

each of the spray outlets comprises an anti-drip means chamber at a first end and at least one spray outlet opening at a second end opposite the first end; the anti-drip means chamber and the spray outlet opening of each of the spray outlets are in water communication with each other;

each of the anti-drip means chambers is disposed with a water pressure actuated anti-drip means which is operable between an open position where water from the body is allowed to pass through the anti-drip means and exits through the spray outlet opening and a close position where water from the body is blocked by the anti-drip means and thus could not exit through the spray outlet opening.

The anti-drip means may be in form of a water pressure relief valve.

The water pressure relief valve comprises a valve casing and a valve member; the valve casing has an upper end which is water sealingly coupled with an annular wall of the anti-drip means chamber, for example by means of an upper sealing ring; the valve casing is provided with a valve seat at a lower end for receiving a lower end of the valve member; when the anti-drip means is in the close position, an outer periphery of an upper portion of the valve member is urged by a spring to abut against an inner wall of an upper portion of the valve casing to block water from the body from exiting through the spray outlet opening, and when water pressure generated by water from the body exceeds a predetermined level, it overcomes biasing force of the spring and the valve member is pushed towards a lower end of the valve seat to form a gap between the outer periphery of the upper portion of the valve member and the inner wall of the upper portion of the valve casing, thus changing the anti-drip means to the open position where water from the body could pass through the gap and exits through the spray outlet opening. A lower sealing ring is disposed in an annular recess formed in the outer periphery of the upper portion of the valve member to improve water sealing effect in the close position.

Alternatively, the anti-drip means may be in form of a cup seal having an annular periphery made of a resilient material; when the anti-drip means is in the close position, the annular periphery is urged against an annular wall of the anti-drip means chamber to block water from the body from exiting through the spray outlet opening, and when water pressure generated by water from the body exceeds a predetermined level the annular periphery of the cup seal is pushed away from the annular wall of the anti-drip means chamber to form a gap between the annular periphery and the annular wall of the anti-drip means chamber, thus changing the anti-drip means to the open position where water from the body could pass through the gap and exits through the spray outlet opening.

In some embodiments, a spring is disposed between the cup seal and a bottom end of the anti-drip means chamber to maintain the cup seal in position.

The cup seal may be made of Nitrile-Butadiene Rubber, Standard Indonesian Rubber or EPDM rubber.

Each of the anti-drip means chamber has a diameter of 2-20 mm.

As the space between the anti-drip means and the spray outlet opening is very small and could contain only very little volume of water, after the little volume of water in the space between the anti-drip means and the spray outlet opening is discharged from the spray outlet opening, no more water will be dripped out from the spray outlet opening. Therefore, dripping from the spray outlet opening on the cover plate of the showerhead could be minimized after the water supply is switched off.

### BRIEF DESCRIPTION OF THE DRAWINGS

FIG. 1 is a cross sectional view of the first embodiment of the present invention when the anti-drip means is at the close position.

FIG. 2 is a cross sectional view of the first embodiment of the present invention when the anti-drip means is at the open position.

FIG. 3 is a perspective view of the cover plate of the first embodiment of the present invention.

FIG. 4 is another perspective view of the cover plate of the first embodiment of the present invention.

FIG. 5 is a perspective view of the water pressure relief valve of the first embodiment of the present invention.

FIG. 6 is another perspective view of the water pressure relief valve of the first embodiment of the present invention.

FIG. 7 is a sectional view of the water pressure relief valve of the first embodiment of the present invention at the close position.

FIG. 8 is a sectional view of the water pressure relief valve of the first embodiment of the present invention at the open position.

FIG. 9 is a cross sectional view of the second embodiment of the present invention when the anti-drip means is at the close position.

FIG. 10 is a cross sectional view of the second embodiment of the present invention when the anti-drip means is at the open position.

FIG. 11 is a perspective view of the cover plate of the second embodiment of the present invention.

FIG. 12 is another perspective view of the cover plate of the second embodiment of the present invention.

FIG. 13 is a perspective view of the cup seal of the second embodiment of the present invention.

FIG. 14 is another perspective view of the cup seal of the second embodiment of the present invention.

FIG. 15 is a sectional view of the cup seal of the second embodiment of the present invention.

### DETAILED DESCRIPTION OF THE INVENTION

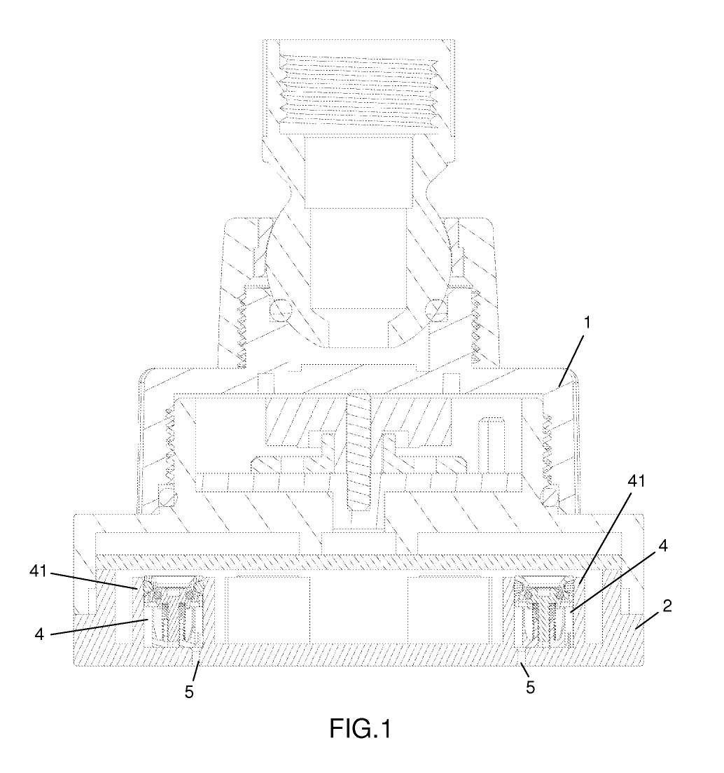

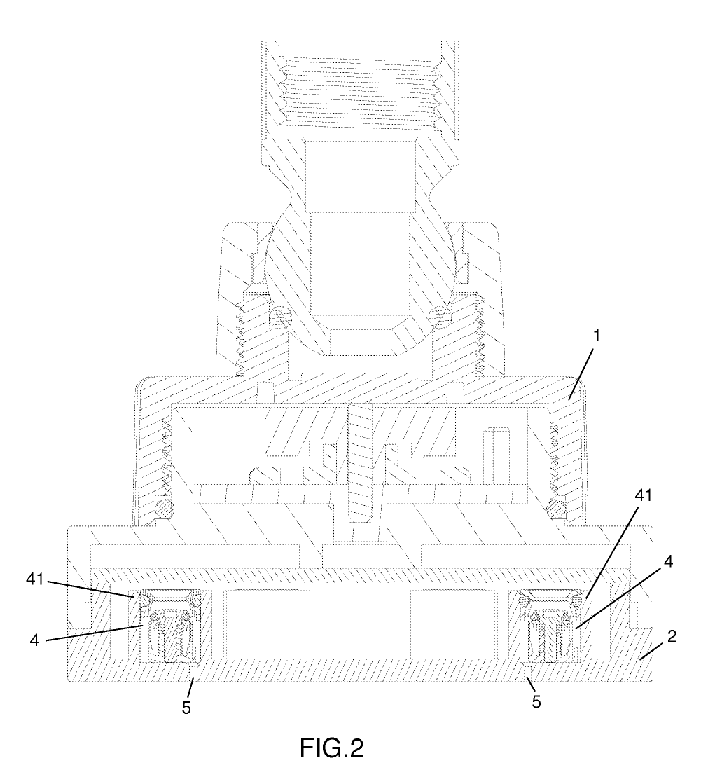

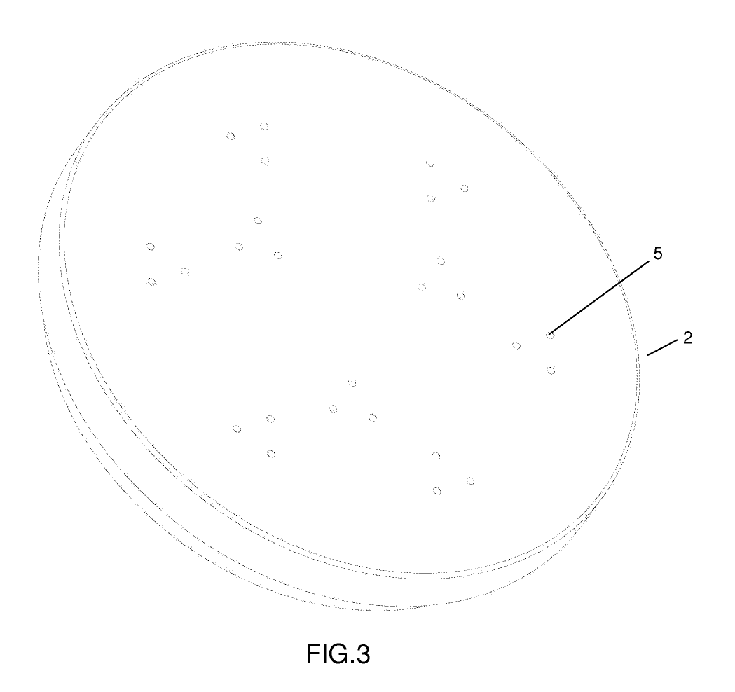

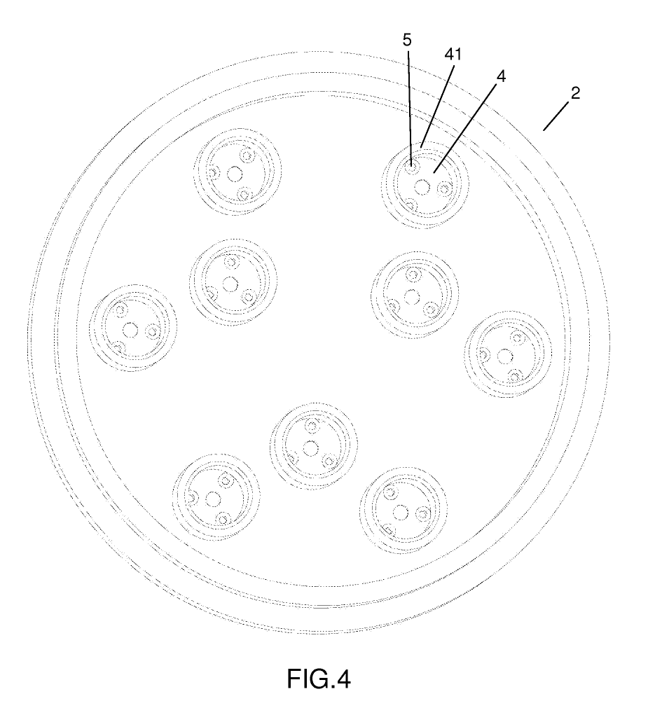

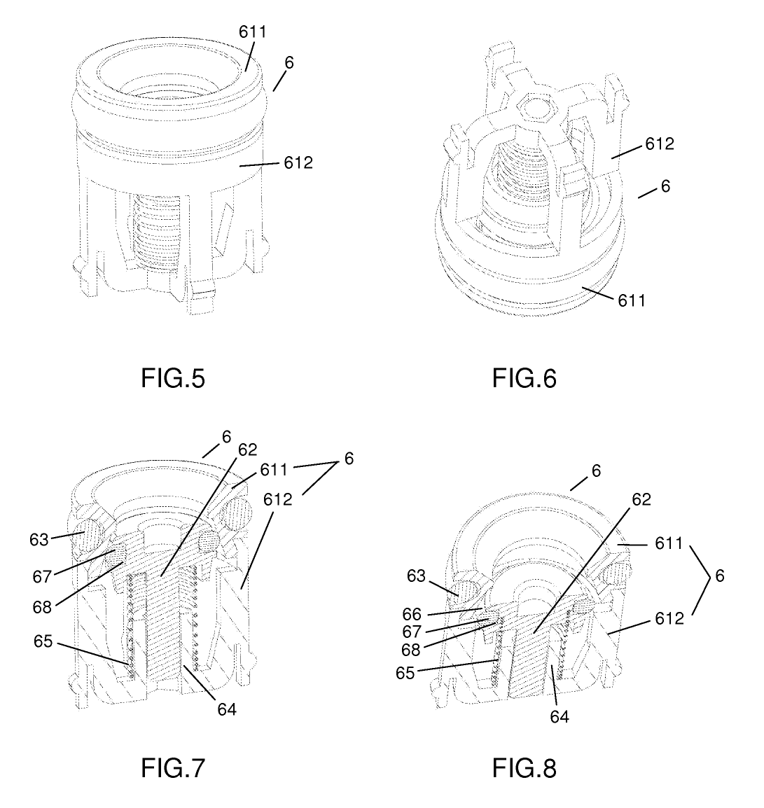

As illustrated in FIGS. 1 to 8, a first embodiment of the present invention comprises a body 1, a cover plate 2 attached to one end of the body 1 in a water-sealed manner and a plurality of spray outlets opened on the cover plate 2. Each of the spray outlets comprises an anti-drip means chamber 4 at a first end and three spray outlet openings 5 at a second end opposite the first end. The anti-drip means chamber 4 and the spray outlet openings 5 of each of the spray outlets are in water communication with each other. Each of the anti-drip means chambers 4 is disposed with a water pressure actuated anti-drip means 6 which is operable between an open position where water from the body 1 is allowed to pass through the anti-drip means 6 and exits through the spray outlet openings 5 and a close position where water from the body 1 is blocked by the anti-drip means 6 and thus could not exit through the spray outlet openings 5.

In the embodiment, the anti-drip means 6 is in form of a water pressure relief valve. The water pressure relief valve comprises a valve casing 61 and a valve member 62. The valve casing 61 in this embodiment is formed by an upper valve casing 611 and a lower valve casing 612 fixedly coupled with each other. The upper valve casing 611 defines an upper end of the valve casing 61 which is water sealingly coupled with an annular wall 41 of the anti-drip means chamber 4 by means of an upper sealing ring 63. The lower valve casing 612 is provided with a valve seat 64 at a lower end for receiving a lower end of the valve member 62. When the anti-drip means 6 is in the close position, an outer periphery of an upper portion of the valve member 62 is urged by a spring 65 to abut against an inner wall of an upper portion of the upper valve casing 611 to block water from the body 1 from exiting through the spray outlet openings 5. When water pressure generated by water from the body 1 exceeds a predetermined level, it overcomes biasing force of the spring 65 and the valve member 62 is pushed towards a lower end of the valve seat 64 to form a gap 66 between the outer periphery of the upper portion of the valve member 62 and the inner wall of the upper portion of the upper valve casing 611, thus changing the anti-drip means 6 to the open position where water from the body 6 could pass through the gap 66 and exits through the spray outlet openings 5. A lower sealing ring 67 is disposed in an annular recess 68 formed in the outer periphery of the upper portion of the valve member 62 to improve water sealing effect in the close position.

In operation, when a user turns on a faucet, water from the water supply enters the body 1 and passes through the passageways inside the body 1 until the water reaches the cover plate 2. As the water enters each of the anti-drip means chambers 4 on the cover plate 2, water pressure of the water overcomes the biasing force of the spring 65 and the valve member 62 is pushed towards a lower end of the valve seat 64 to form a gap 66 between the outer periphery of the upper portion of the valve member 62 and the inner wall of the upper portion of the upper valve casing 611, thus changing the anti-drip means 6 to the open position where water from the body 1 could pass through the gap 66 and exits through the spray outlet openings 5.

When the user turns off the faucet, water from the water supply stops entering the body 1, thus water pressure of the water in the body 1 drops. The valve member 2 is urged by the spring 65 to abut against the inner wall of the upper portion of the upper valve casing 611 to block water from the body 1 from exiting through the spray outlet openings 5; in other words, the anti-drip means 6 returns to the default close position.

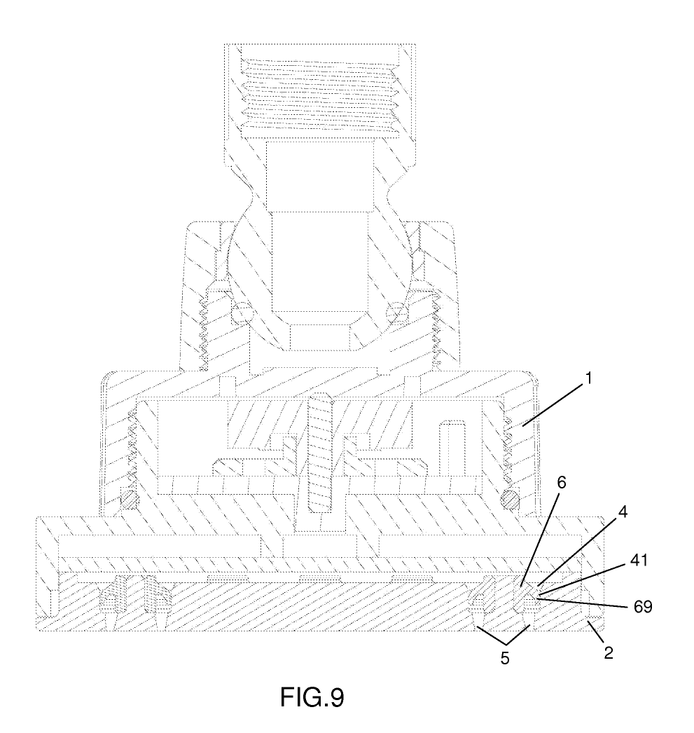

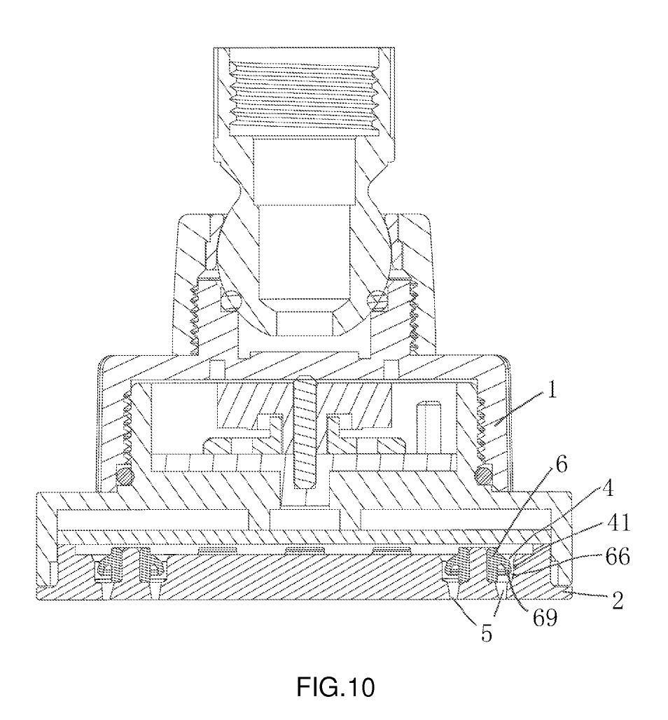

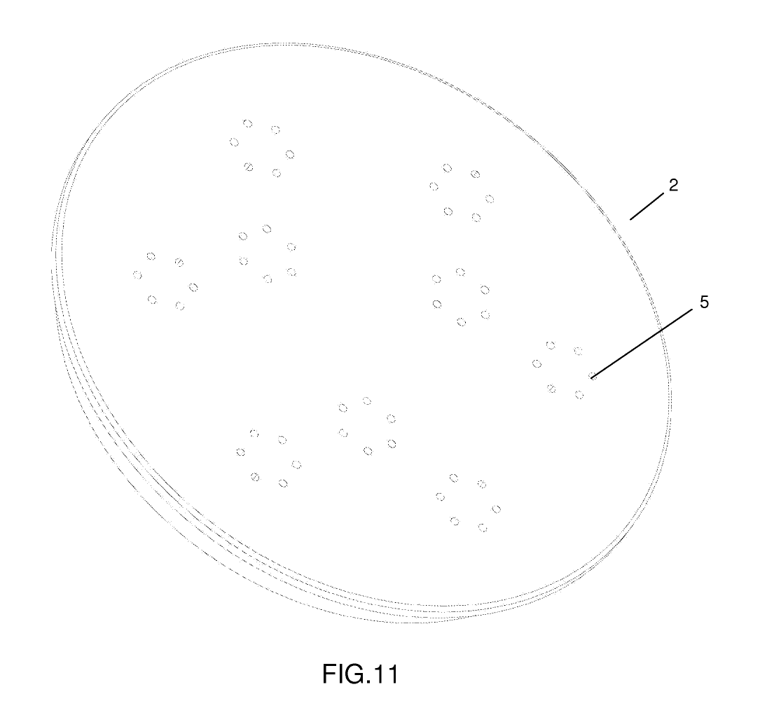

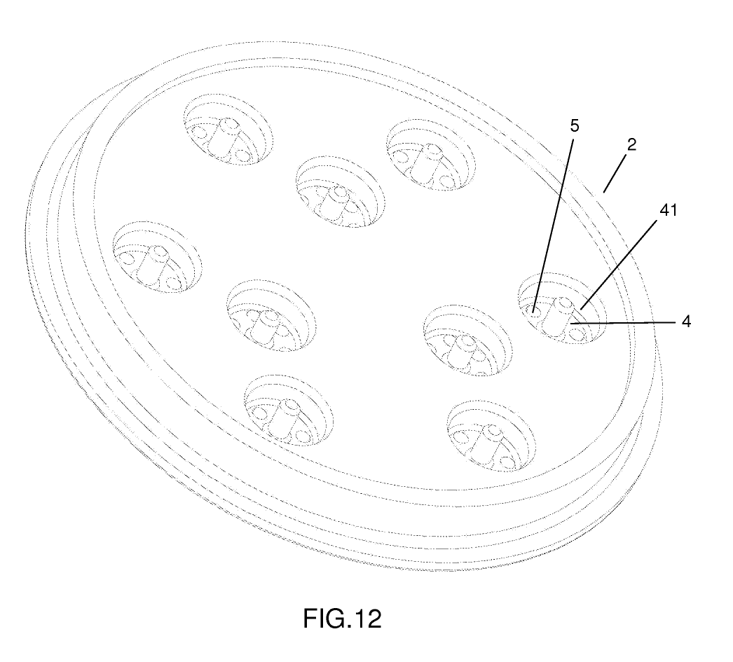

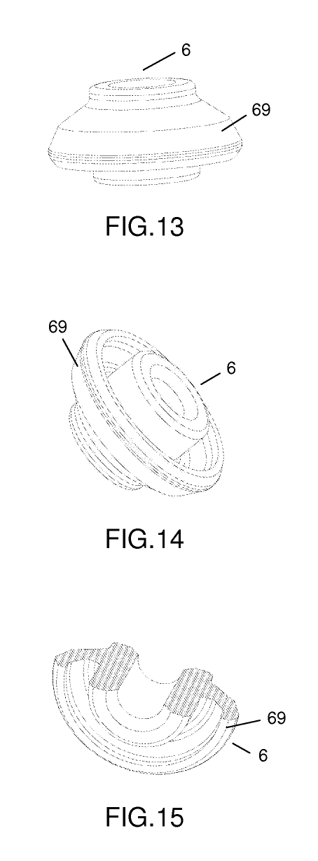

FIGS. 9 to 15 illustrate a second embodiment of the present invention. The second embodiment is substantially similar to the first embodiment except for the following. In the second embodiment, each of the spray outlets comprises an anti-drip means chamber 4 at a first end and six spray outlet openings 5 at a second end opposite the first end. The anti-drip means 6 is in form of a cup seal having an annular periphery 69 made of a resilient material such as Nitrile-Butadiene Rubber, Standard Indonesian Rubber or EPDM rubber. When the anti-drip means 6 is in the close position, the annular periphery 69 is urged against an annular wall 41 of the anti-drip means chamber 4 to block water from the body 1 from exiting through the spray outlet openings 5, and when water pressure generated by water from the body 1 exceeds a predetermined level the annular periphery 69 of the cup seal is pushed away from the annular wall 41 of the anti-drip means chamber 4 to form a gap 66 between the annular periphery 69 and the annular wall 41 of the anti-drip means chamber 4, thus changing the anti-drip means 6 to the open position where water from the body 1 could pass through the gap 66 and exits through the spray outlet openings 5.

In operation, when a user turns on a faucet, water from the water supply enters the body 1 and passes through the passageways inside the body 1 until the water reaches the cover plate 2. As the water enters each of the anti-drip means chambers 4 on the cover plate 2, water pressure of the water pushes the annular periphery 69 of the cup seal away from the annular wall 41 of the anti-drip means chamber 4 to form a gap 66 between the annular periphery 69 and the annular wall 41 of the anti-drip means chamber 4, thus changing the anti-drip means 6 to the open position where water could pass through the gap 66 and exits through the spray outlet openings 5.

When the user turns off the faucet, water from the water supply stops entering the body 1, thus water pressure of the water in the body 1 drops. As the cup seal is made of a resilient material, and the water pressure of the water in the body is no longer capable of push the annular periphery 69 away from the annular wall 41 of the anti-drip means chamber 4, the cup seal returns to its default close position were the annular periphery 69 is urged against the annular wall 41 of the anti-drip means chamber 4 to block water from the body 1 from exiting through the spray outlet openings 5.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. An anti-drip showerhead comprising
a body;
a cover plate attached to one end of the body in a water-sealed manner;
a plurality of spray outlets opened on the cover plate;
each of the spray outlets comprises an anti-drip means chamber at a first end and at least one spray outlet opening at a second end opposite the first end; the anti-drip means chamber and the spray outlet opening of each of the spray outlets are in water communication with each other;
each of the anti-drip means chambers is disposed with a water pressure actuated anti-drip means which is operable between an open position where water from the body is allowed to pass through the anti-drip means and exits through the spray outlet opening and a close position where water from the body is blocked by the anti-drip means and thus could not exit through the spray outlet opening.

2. The anti-drip showerhead as in claim 1, wherein the anti-drip means is in form of a water pressure relief valve.

3. The anti-drip showerhead as in claim 2, wherein the water pressure relief valve comprises a valve casing and a valve member; the valve casing has an upper end which is water sealingly coupled with an annular wall of the anti-drip means chamber, for example by means of an upper sealing ring; the valve casing is provided with a valve seat at a lower end for receiving a lower end of the valve member; when the anti-drip means is in the close position, an outer periphery of an upper portion of the valve member is urged by a spring to abut against an inner wall of an upper portion of the valve casing to block water from the body from exiting through the spray outlet opening, and when water pressure generated by water from the body exceeds a predetermined level, it overcomes biasing force of the spring and the valve member is pushed towards a lower end of the valve seat to form a gap between the outer periphery of the upper portion of the valve member and the inner wall of the upper portion of the valve casing, thus changing the anti-drip means to the open position where water from the body could pass through the gap and exits through the spray outlet opening.

4. The anti-drip showerhead as in claim 3, wherein a lower sealing ring is disposed in an annular recess formed in the outer periphery of the upper portion of the valve member to improve water sealing effect in the close position.

5. The anti-drip showerhead as in claim 1, wherein the anti-drip means is in form of a cup seal.

6. The anti-drip showerhead as in claim 5, wherein the cup seal has an annular periphery made of a resilient material; when the anti-drip means is in the close position, the annular periphery is urged against an annular wall of the anti-drip means chamber to block water from the body from exiting through the spray outlet opening, and when water pressure generated by water from the body exceeds a predetermined level the annular periphery of the cup seal is pushed away from the annular wall of the anti-drip means chamber to form a gap between the annular periphery and the annular wall of the anti-drip means chamber, thus changing the anti-drip means to the open position where water from the body could pass through the gap and exits through the spray outlet opening.

7. The anti-drip showerhead as in claim 6, wherein a spring is disposed between the cup seal and a bottom end of the anti-drip means chamber to maintain the cup seal in position.

8. The anti-drip showerhead as in claim 6, wherein the cup seal is made of Nitrile-Butadiene Rubber, Standard Indonesian Rubber or EPDM rubber.

9. The anti-drip showerhead as in claim 1, wherein each of the anti-drip means chamber has a diameter of 2-20 mm.
